(19) United States
(12) Patent Application Publication
(10) Pub. No.: US 2026/0289632 A1
(43) Pub. Date: Sep. 24, 2026

(54) REAL-TIME OFFER MANAGEMENT AND PUBLISHING

(71) Applicant: FETCHERR LTD, Netanya (IL)

(72) Inventor: Roy COHEN, Netanya (IL)

(21) Appl. No.: 19/475,743

(22) PCT Filed: Apr. 16, 2024
(86) PCT No.: PCT/IL2024/050373

§ 371 Date: Oct. 15, 2025

Related U.S. Application Data
(60) Provisional application No. 63/463,028, filed on Apr. 30, 2023.

(51) Int. Cl. G06Q 30/0601

(52) U.S. Cl. CPC G06Q 30/06291; G06Q 30/0611

(57) ABSTRACT

Provided herein are system and methods for real-time management and publishing of offers, such as airline travel offers, wherein each offer is represented by a dynamic Standard Identification Number (STIN), allowing traceability of the products unis represented by the STIN.

### FIELD OF THE INVENTION

Embodiments of the disclosure relate to systems and methods for real-time management and publishing of offers, such as airline travel offers, wherein each offer is represented by a dynamic Standard Identification Number (STIN).

### BACKGROUND

Most searches for flights/travel by a potential costumer being with a search engine, where most of the links a customer will find are sponsored based on key words and not necessarily based on the actual search. When the costumer selects a result (link), he will be referred to an Airline website or an Online Travel Agents (OTA)/Metasearch sites, where he will be presented with a brand new search engine that will require him to search again in order to fetch the most updated prices. Consequently, over 85% of users that reach airline websites abandon the purchase on the website because the prices seen on meta searches or on search engines are different than those on the airline website.

Currently, Airlines publish their fares to central GDS (Global Delivery Systems). These systems are where all prices from all airlines are published to, and where OTAs and search engines pull their pricing information. Search engines have no access to up-to date pricing and availability because it is gated by GDSs and OTAs that are fraught with latency issues and relatively error rates. Accordingly, when the customer searches for a flight on a search engine and arrives at an OTA or a Metasearch site, he must search for the same prompt again to initialize the process of price updating through the GDS systems.

There is therefore a need for systems and methods enabling real-time traceability and indexing of airlines inventory and facilitating real-time creation, updating and publishing of travel offers, which are accessible to a costumer via various on-line platforms.

### SUMMARY

According to some embodiments, there are provided herein systems and methods for real-time management (including creating, updating and publishing) of travel offers, wherein each travel offer is represented by a dynamic and traceable standard ticket identification number (STIN). According to some embodiments, the systems and methods disclosed herein are computer implemented methods or platforms utilizing AI models (in particular, generative AI engine) which are used for real time indexing and/or updating inventory, real time creating and/or updating unique and dynamic STINs (each representative of a travel offer), real time pricing of STINs, real time publishing of STINs to search engines or other relevant websites (such as airline websites, 3^{rd} party websites, etc.), to thereby allow real-time, accurate, convenient and efficient management of travel offers.

Advantageously, the herein disclosed methods and systems applies AI models, such as machine learning (ML), on various structured data to derive features which can subsequently be used to generate real-time, dynamic and traceable STINs representing distinct/singular/one to one, travel offers, based on, for example, but not limited to: real-time indexed inventory, search prompt(s), user input, data related to the user, related events data (environmental data), and the like, or any combinations thereof. Each possibility is a separate embodiment.

Advantageously, as detailed below herein, the STIN created by the systems and methods disclosed herein, is a unique and specific, dynamic and changing identification number, based on the generated travel offer, while having the price associated with the offer adjusting accordingly. An STIN represents an offer that is tailored to the customer from various, different combinations of products. Each part/portion of the STIN signifies a product unit in the travel offer, making every single possible offer traceable down to the sub-products that are included in the offer. Consequently, the STIN can represent an infinite amount of offers without having to maintain an infinite catalog of singular products or offers. Once the customer checks in to a flight, that part of the STIN becomes static and represents the final offer paid for, and the product consequently perishes.

As a further advantage, the herein disclosed methods and systems allow for creation and updating of an indexed inventory network (IIN), which allows airlines to directly publish their real-time inventory and prices without the need to go through Global Delivery Systems (GDS), further allowing interoperability between various airlines and bundling of flight offers across airlines without prior agreements.

Moreover, advantageously, the systems and methods utilizing the generative AI Matching Engine and the IIN, enable airlines to switch from query based pricing and publishing to true push capabilities. Any input into the system will automatically and instantly induce updates within the IIN, resulting in a push of an action at the other end of the system. This would thus affect everything within the IIN seamlessly with minimal latency and ensure the most up to date availability and pricing across all marketing channels. For example, with a direct connection to search engines, the search engines always have access to the most up to date products and pricing without needing to query the information. The IIN will be pushed updates constantly and a search engine (having access to the IIN) will be able to view it, as prices and products availability change on the shelf in real time.

As an additional advantage, the systems and methods disclosed herein allow a supplier (for example, an airline) and costumer, real-time traceability of an offer (which may be constructed from separate unrelated product units, such as baggage allowance, insurance, meal upgrades, etc.). As the STIN bundles up every single product unit purchased in one offer, it allows both the buyer and the supplier to trace each one through the entire supply chain, from payment, to booking, to check in.

Moreover, advantageously, the real-time traceability not only allows the supplier to accurately track its real-time inventory of products but can also affect planning and enhanced functionality of the supplier. For example, an airline can accurately track the number of checked-in baggage planned on a flight and consequently accurately plan weight loads and workforce. Additionally, for example, an airline can transmit an accurate and live assessment of its last available seat (which is currently otherwise not possible). The reason being that currently when booking a flight, hotel and car through an airline, the buyer is essentially making three different bookings with the airline each having their own funnel of traceability. When searching for a change within one of the ordered products, the buyer will encounter hurdles, because order number only refers to the booking with the airline, separating the buyer from the other products that were actually purchased. The separation extends to the airlines as well since they have no access except for the booking agreement with the other suppliers. The booking with the airline itself is usually done through OTAs making the ticket the customer bought completely untraceable to the seat at the end of the funnel.

Consequently, as a further advantage, airlines using STIN are able to effectively market flights and bundle offers through a variety of channels, with a direct link to checkout of the exact offer advertised since it is associated with a Dynamic STIN, that bundles all products of that offer and is being real-time updated constantly.

According to some embodiments, there is provided a computer implemented method executable on a processor for creating a traceable dynamic Standard Ticket Identification Number (STIN) representing a travel offer, the computer implemented method includes:
creating and/or updating one or more Indexed Inventory Networks (IINs) representing real time availability of product units offered for sale by one or more respective airlines, wherein the IIN is continuously updating at least prices and availability of the product units, wherein the IIN is accessible by a search engine utilizing an inventory key;
generating, utilizing a generative AI matching engine, a STIN representing a one-to-one travel offer based on data obtained from the IIN and a set of travel preferences provided by a user, wherein the STIN is dynamically updatable based on relevant changes in the IIN and/or in the travel preferences;
using the generative AI matching engine, matching a pricing to the STIN represented one-to-one travel offer, based at least on data from the IIN; and
pushing the STIN and price thereof to a search engine and/or a website.

According to some embodiments, the method may further include updating the IIN in real time, upon a generation of the STIN.

According to some embodiments, the method may further include receiving a travel search prompt via the search engine and/or website from a customer, wherein the generation or an update of the STIN is further based on one or more travel search prompt characteristics.

According to some embodiments, the method may further include updating the IIN in real time, upon a purchase of an STIN represented travel offer by a costumer.

According to some embodiments, the method may further include dynamically and traceably updating the STIN based on changes requested by the user and/or a customer (for example, change of dates, addition/deletion of ancillaries) or by changes in the IIN (for example, airline related changes, such as a change of an aircraft).

According to some embodiments, the method may further include inputting to the generative AI matching engine data related to the customer and/or environmental data, thereby generating a personalized STIN; and updating the matched pricing accordingly.

According to some embodiments, data related to the costumer may include costumer prior preferences, prior travel habits, prior travel behavior, financial status, social status, any General Data Protection Regulation (GDPR) approved data, or any combinations thereof. Each possibility is a separate embodiment.

According to some embodiments, the environmental data may include concerts, sport events, holidays, weather, festivals, any publicly available information, or any combinations thereof. Each possibility is a separate embodiment.

According to some embodiments, the method may further include updating the matched price.

According to some embodiments, the STIN comprises a representation (i.e., signifies) of seat serial number (SSN), departure date and time, on-site ancillaries, off-site ancillaries, length of stay, or any combinations thereof. Each possibility is a separate embodiment.

According to some embodiments, the SSN signifies one or more of: carrier (airline), airline unique identifier (aircraft number); seat number, or combinations thereof. Each possibility is a separate embodiment.

According to some embodiments, the on-site ancillaries may include one or more of: baggage allowance, carry-on baggage allowance, loyalty, frequent flyer, meal(s) type, any other ancillary owned by the airline company, or any combinations thereof. Each possibility is a separate embodiment.

According to some embodiments, the off-site ancillaries comprise one of more of: car rentals, excursions, hotels, airport transfers, any ancillary the airline sells via a contract with another supplier, or any combinations thereof. Each possibility is a separate embodiment.

According to some embodiments, updating the IIN in real time may include updating data relating to seat map (SSN) and live availability thereof, on-site ancillary index, schedule of flights index, off-site ancillaries index, or any combination thereof. Each possibility is a separate embodiment.

According to some embodiments, there is provided a computer implemented method executable on a processor, for creating a traceable dynamic Standard Ticket Identification Number (STIN) representing a travel offer, the computer implemented method comprising:
monitoring travel search prompts by a costumer via a search engine and/or a website (for example, of an airline or a 3rd party supplier);
utilizing an inventory key, facilitating access of the search engine to an Indexed Inventory Networks (IIN) representing real time availability of product units offered for sale by one or more airlines,
generating, utilizing a generative AI matching engine, a STIN representing a one-to-one travel offer based on data obtained from the IIN and on one or more travel search prompt characteristics;
using the generative AI matching engine, matching a pricing to the STIN represented one-to-one travel offer, based at least on data from the IIN; and
pushing the STIN and price thereof to the search engine.

According to some embodiments, the method includes providing to the customer a direct link to an airline website or 3rd party supplier website for purchasing the travel offer.

According to some embodiments, the method may further include updating the IIN in real time, upon a purchase of an STIN represented travel offer by the customer.

According to some embodiments, the method may further include dynamically and traceably updating the STIN based on changes requested by the customer or by changes in the IIN. According to some embodiments, the method may further include inputting to the generative AI matching engine data related to the customer and/or environmental data, thereby generating a personalized STIN; and updating the matched pricing accordingly.

According to some embodiments, the method may further include updating the matched price.

According to some embodiments, the STIN includes a representation of SSN, departure date and time, on-site ancillaries, off-site ancillaries, stay days, or any combinations thereof.

According to some embodiments, updating the IIN comprises real time updating data relating to seat map (SSN) and live availability thereof, on-site ancillary index, schedule of flights index, off-site ancillaries index, or any combination thereof.

According to some embodiments, there is provided a computer-implemented method for creating an Indexed Inventory Network (IIN), the method comprising:
obtaining an inventory list of an airline product units;
indexing the product units by assigning or tagging one or more of the indexes selected from: index of seat map (SSN), on-site ancillary index, schedule of flights index and/or off-site ancillaries index;
generating an inventory key;
determining live availability of indexed product units; and
allowing a search engine (and/or website) access to the IIN, utilizing the inventory key.

According to some embodiments, the method may further include continuously updating at least prices and availability of the product units in the IIN.

According to some embodiments, the method may further include the IIN is cloud based, stored on a local or remote server.

According to some embodiments, the IIN is configured to push updates to the search engine (and/or website), when at least the prices and/or availability of products are updated.

According to some embodiments, there is provided a system for generating a traceable dynamic Standard Ticket Identification Number (STIN) representing a travel offer, the system includes at least one processor unit configured to execute at least one method for generating an STIN as disclosed herein.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE DRAWINGS

Some embodiments are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 schematically shows an outline of an AI-based platform for real-time management (creation and updating) of travel offers (represented by Standard Ticket Identification Numbers (STINs), according to some embodiments;

FIG. 2 schematically shows an exemplary representation of an STIN, according to some embodiments;

FIGS. 3A-C, schematically shows an outline of exemplary creation of indexed live inventory of travel products, according to some embodiments;

FIG. 4, shows an illustrative flow chart of a method for generating an indexed inventory network (IIN), according to some embodiments;

FIG. 5 schematically shows an outline of creation, management and traceability of STINs representing travel offers, according to some embodiments;

FIG. 6 schematically shows an exemplary outline of creation, pricing and publishing of travel offers, using the herein disclosed AI-based platform;

FIG. 7 is an illustrative flow chart of a method for creating a traceable dynamic Standard Ticket Identification Number (STIN) representing a travel offer, according to some embodiments;

FIG. 8 is an illustrative flow chart of a method for creating a traceable dynamic Standard Ticket Identification Number (STIN) representing a travel offer, according to some embodiments; and

FIG. 9 is an illustrative diagram of an STIN-enabled purchase process of a travel offer by a customer, according to some embodiments.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

According to some embodiments, there are provided herein AI-based methods and systems for creating (generating), updating and publishing real-time travel offers, based on real-time created or updated indexed inventory network of suppliers(s) (for example, airline), wherein each of the offers is associated with a traceable and dynamic identification number (also referred to herein as standard travel identification number (STIN)), representing all the product units/sub-units which are included with the travel offer.

As used herein, the term “airline” relates to an airline company offering/selling flights and optionally one or more additional related products, to one or more destinations.

As used herein, the term “3^{rd}-party supplier” may include any online or otherwise supplier or advertiser of travel products. In some embodiments, a 3^{rd}-party supplier may include Metasearch engines, online travel agency (OTA), Global distribution system (GDS), Travel agency, Travel Marketing Agencies, Corporate, Aggregator, and the like, or any combinations thereof. In some embodiments, a 3^{rd} party supplier may be an online travel agency (OTA) that can offer direct purchase of flights, or metasearch engines. Exemplary 3^{rd} party suppliers include, for example, but not limited to: Trivago, Kayak, Skyscanner, Expedia, Booking, TripAdvisor, and the like.

As used herein, the term “search engine” is directed to an internet search engine (a web service), that searches for information on the internet and designed to retrieve specific information, based on input (search) from a user. In some embodiments, a search engine also encompasses metasearch which is a search engine having defined search parameters. Exemplary search engines include, for example, Google and Bing. In some embodiments, a search engine also encompasses Large Language Models (LLM) searches.

As used herein, the term “website” relates to an online accessible, internet-based site of an entity (supplier). In some embodiments, the website may be of an airline company. In some embodiments, the website may be of a 3^{rd} party supplier. In some embodiments, a website also encompasses an application programming interface (API) of the supplier.

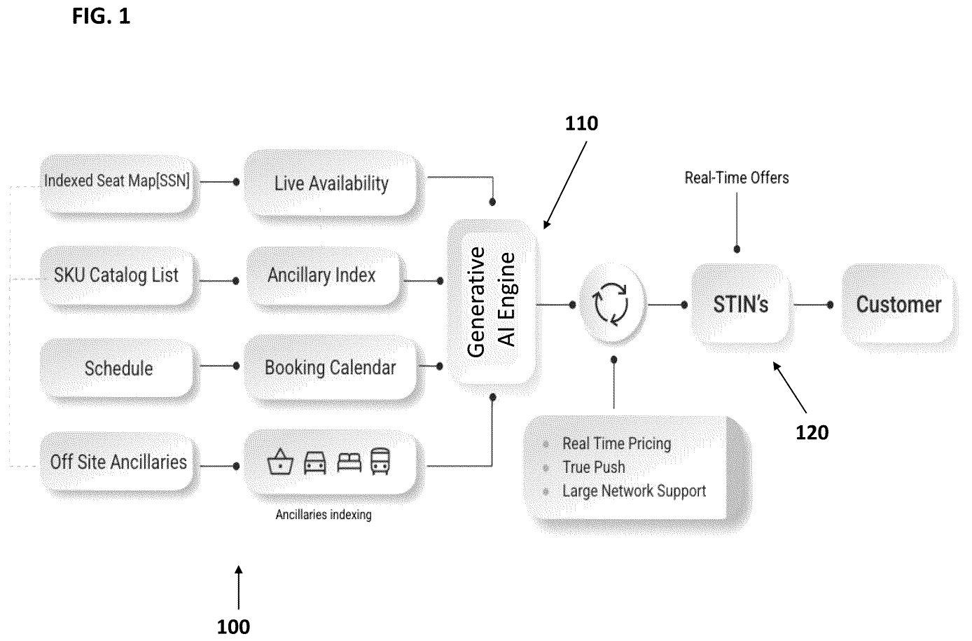

Reference is now made to FIG. 1, which schematically shows an outline of the herein disclosed AI-based platform for real-time management (creation and updating) of travel offers (represented by Standard Ticket Identification Numbers (STINs)), according to some embodiments. As generally shown in FIG. 1, an indexed inventory network (100) which represents an indexed inventory of an airline is created and is constantly being updated in real time (as further detailed herein). The indexed inventory network (IIN) represents all of the products units that are offered and are available, and can include for example, an indexed seat map (SSN), an index of ancillary products offered by the airline (also referred to herein as “on-site ancillaries”), or by other suppliers (“also referred to herein as “off-site ancillaries”), an index of flights schedule, index of other inventory catalog units of the airline (also referred to herein as “SKU”), and the like, all of which are fed/entered/inputted into a generative AI engine 110. Generative AI engine 110, is configured to create/generate a STIN 120, representing a discrete/one-to-one/singular travel offer, based on data obtained from IIN 100, and optionally, a set of travel preferences (for example, provided by a user). As detailed below herein, STIN 120 is dynamically updatable based on, for example, relevant changes in the IIN, changes in the travel preferences, and the like. Generative AI engine 110 is further configured to determine/match/generate/calculate a price of STIN represented travel offer, based at least on data from the IIN (i.e., live inventory) and/or one or more additional sources, such as, travel preferences, related events (also referred to herein as “external events” “external data”, or “environmental events”, such as, festivals, concerts, sport events, holidays, etc.). The platform is further configured to publish, by “pushing” the information (in particular, the STIN) to a customer, for example, via a search engine, or website (airline or 3^{rd} party). As further detailed herein, the real-time management is enabled by constantly and continuously pushing updates to the platform, thereby ensuring that the most updated available inventory is used for the generation, update and matched pricing of the STIN.

According to some embodiments, the generative AI engine (also referred to herein as “AI matching engine offer creator” and “generative AI matching engine”), may utilize any type of suitable algorithms, including, for example, but not limited to: artificial neural network(s) (ANN), such as convolutional neural network (CNN), recurrent neural network (RNN), long-short term memory (LSTM), auto-encoder (AE), generative adversarial network (GAN), Reinforcement-Learning (RL), support vector machine (SVM), decision tree (DT), random forest (RF), and the like. Both “supervised” and “unsupervised” methods may be implemented. As further detailed herein, the AI algorithm may utilize various types of data, information, parameters, values and/or any information derived therefrom, for the creation, updating and pricing of an STIN, including, for example, live (real-time) inventory (based on the IIN), user travel preferences, user characteristics, environmental data, and the like, or any combination thereof.

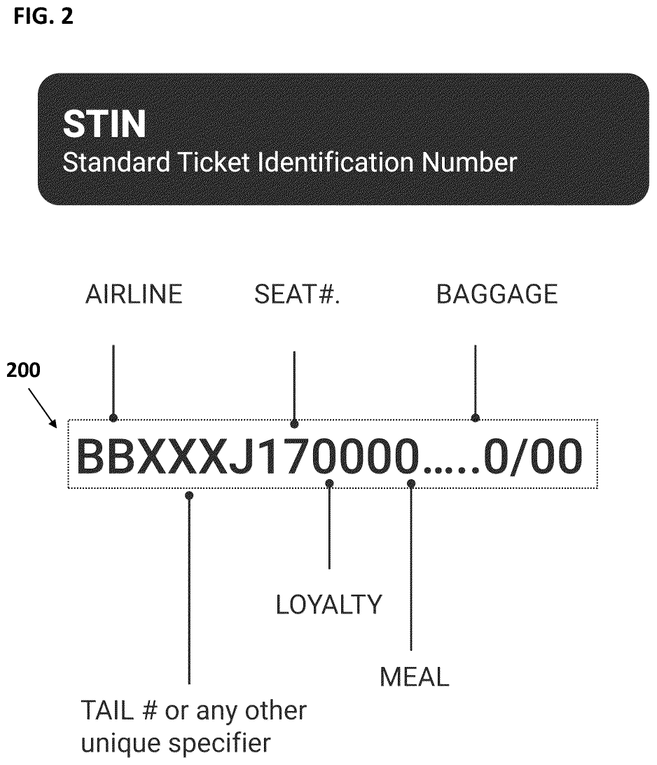

Reference is now made to FIG. 2, which shows an exemplary representation of an STIN, according to some embodiments. As shown in FIG. 2, STIN 200 may be represented as a dynamic serial number, which enables traceability and indexing of airlines inventory. As shown in FIG. 2, the serial number is built from basic identifications of airline inventory (such as airline signifier, seat signifier, class signifier, aircraft (tail number), origin/destination (O/D), and the like), as well as any other product units, sub-products, or signifiers (such as, for example, loyalty, baggage, insurance, meals, excursions, car rental, hotel, etc.). The STIN is dynamic and can change according to the offer generated (with all of its unique features), with the price of the offer adjusting accordingly. Once the customer checks-in to a flight, part of the STIN becomes static and represents the final offer paid for, and the used products perish. As shown in FIG. 2, since a generated offer is tailored to the customer from various different combinations of product units or sub-product, each part/portion/region of the STIN signifies one product unit in the offer, making every single possible travel offer unique and traceable down to the sub-product that makes it. In other words, the STIN “holds” and represents all the units that create/comprise the offer, and each offer has a single/one-to one/unique representing STIN. It is noted that each product can have subsequent products within it, so for example, a seat signifier could have 1,2,3 or more singular seats under one signifier. Flight signifiers can include, for example, the date and time of the flight, since that signals them out as singular products. During the booking process by a customer, as the offer changes, so does the serial number signifying which products from the catalog are a part of that offer. Thus, using STINs can represent an infinite amount of offers without having to maintain an infinite catalog of singular products or offers.

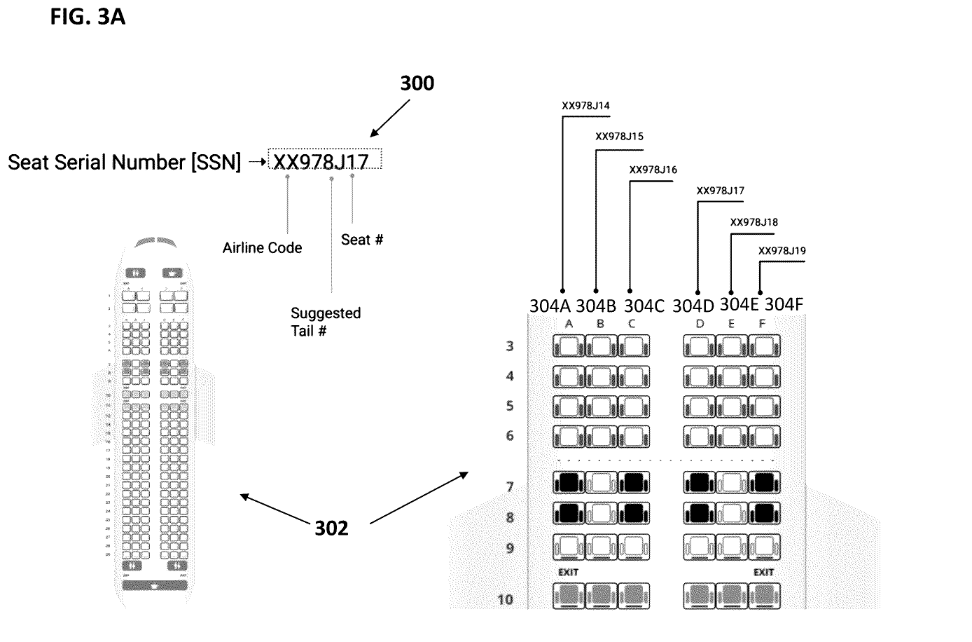

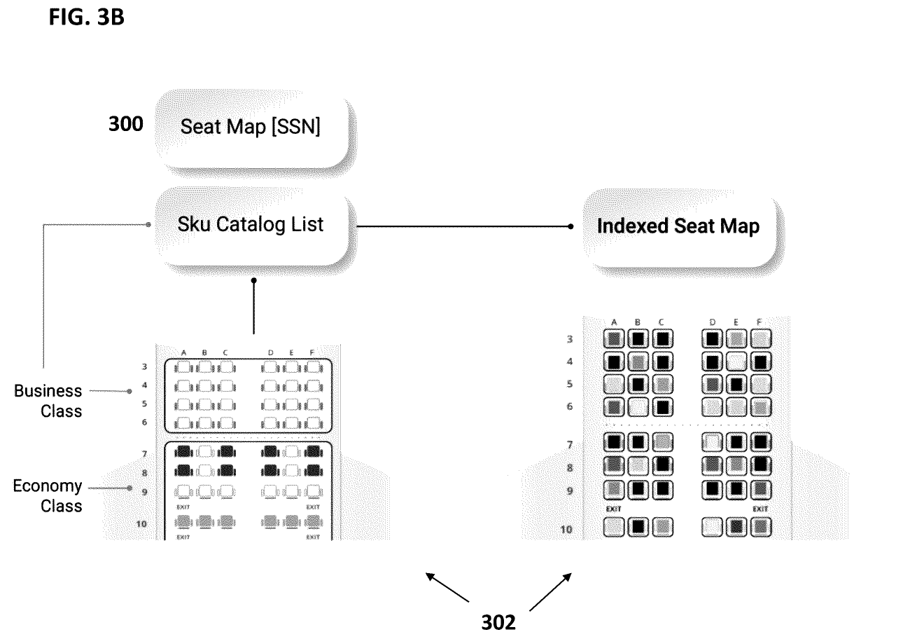

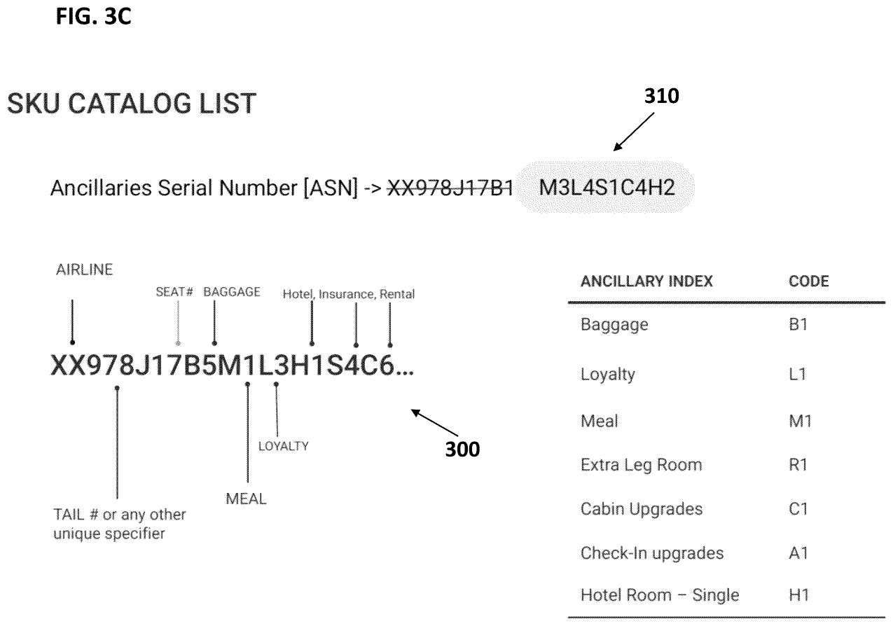

According to some embodiments, in order to create dynamic STINs, an indexed inventory of each airline products is created. After being created, the indexed inventory network can be updated in real time-thereby accurately reflecting real time and most up-to date availability of products. Reference is made to FIGS. 3A-C, which schematically show an outline of exemplary creation of indexed live inventory of travel products, according to some embodiments. Shown in FIGS. 3A-B is exemplary creation/generation of seat serial number (SSN) index for an airline inventory. As shown in FIG. 3A, SSN 300 represents the possible seats of an airline, wherein the possible seats are determined per aircraft (represented by a tail number or other airline unique identifier, the aircraft is illustrated as exemplary aircraft 302). Thus, for example, each of seats marked as 304A-F (seats A-F positioned in row 3 in aircraft 302) is assigned a different SSN, corresponding to the specific respective seat. As shown in FIG. 3B, the SSN 300 can be further classified and indexed according to travel class (business, economy, tec), category (extra leg room, exit seat), location within the aircraft (front, center, rear, window, middle seat, etc.), and/or any other available catalog units (“SKU”) of an airline. The SSN assigns a reference (identifier) to each of the seats, which as shown in FIG. 3A, may be comprised, for example of identifiers such as, airline identifier (“airline code”), aircraft identifier (“Tail #” or other airline unique identified), and seat identifier. As can be understood, each SSN is specific to a designated seat of a designated aircraft of a designated airline. As detailed herein, the SSN index forms a basis for the IIN, and may further be used as part of an STIN, representing a specific travel offer. In some embodiments, real-time availability of an SSN may be determined or updated by the AI engine creator. As shown in FIG. 3C, various additional ancillary catalog product units (“SKU”) may be indexed and assigned a reference value (also referred to herein as “ASN” 310), which is also used as part of a generated STIN 300. Such additional product units may include, for example, on-site ancillaries and/or off-site ancillaries, such as, but not limited to baggage, loyalty, meals, leg-room, upgrades, rentals, hotels, and the like.

According to some embodiments, in order to create and/or update an STIN, an IIN is created and/or updated. As detailed herein, the IIN is an organized and tagged inventory of all product units/sub-products that are available for sale by the airline. This IIN is constantly being updated with prices and availability and is assigned with an inventory key, allowing/preventing access thereto. The inventory key allows controlling which entity (for example, which search engine) can be provided with direct access to the INN. In other words, the IIN is accessible by anyone the holds the Inventory Key. By being provided with the inventory key, entities (such as search engines), can access the IIN directly and create bespoke offers directly from the search engine. This will in turn drive traffic back to the airlines or other websites. In some embodiments, the traffic is turned back to airlines and not to OTAs or Meta Searches, because the offers generated from the IIN (i.e., the STINs) will only direct customers to the airline website. Such seamless connection between a search engine and the IIN itself creates a shorter purchase process that is tailored to the customer. When a user executes a search, the search engine that is connected to the IIN of the airline using the Inventory Key, gets an instant push with an STIN that fits the user's search prompt. The STIN and offer pushed is a direct link to a checkout page connected to the same STIN on the airline website. The IIN allows airlines to directly publish their inventory and prices without the need to go through cumbersome GDS systems. According to some embodiments, the IIN may be stored on a remote server, or a cloud platform, accessible over a communication network. In some exemplary embodiments, the IIN is cloud-based. In some embodiments, the IIN is generated for each airline and is constantly being updated, in real-time at least with availability and/or pricing. In some embodiments, each IIN has a unique inventory key. In some embodiments, the IIN is not accessible without an inventory key. According to some embodiments, the IIN and the generative AI matching engine enable airlines to switch from query-based pricing and publishing to True Push. Any input into the system will create a chain reaction within the IIN, resulting in a push of an action at the other end. This will affect everything within the IIN seamlessly with minimal latency and ensure the most up to date availability and pricing across all marketing channels. With a direct connection to search engines (such as Google, LLMs), the search engines will always have access to the most up to date products and pricing without needing to query the information. The IIN will be pushed updates constantly and the search engine is able view this in real time as prices and products changing on the shelf.

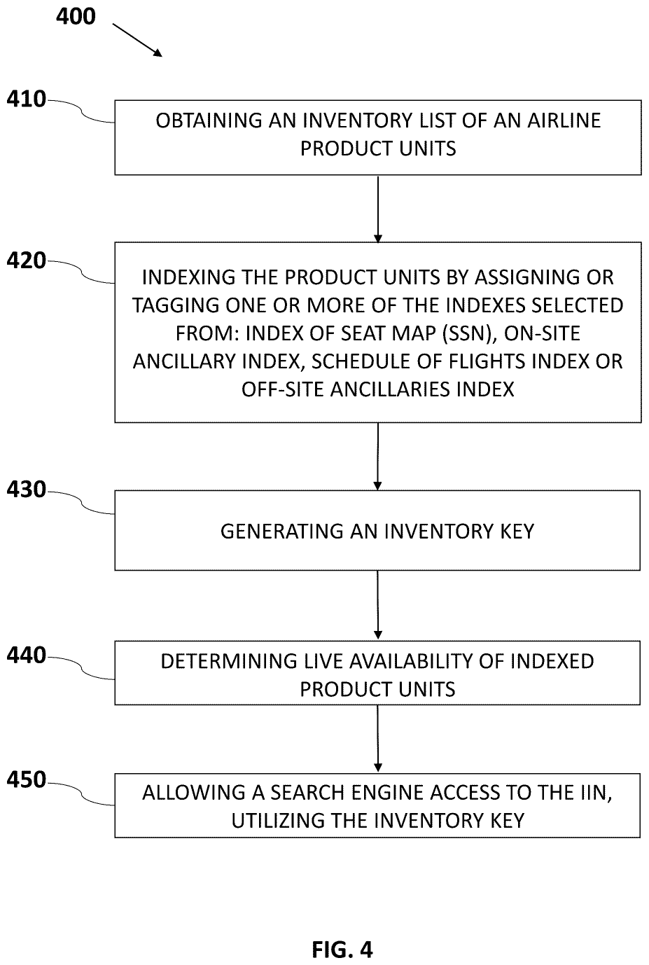

Reference is now made to FIG. 4, which shows an illustrative flow chart of a method for generating an indexed inventory network (IIN), according to some embodiments. As shown in FIG. 4, method 400 includes at step 410 obtaining the inventory list of an airline product units. Such a list includes product units or sub products available for sale by the airline, including, for example, but not limited to: aircrafts (type, number, size, age, maintenance, etc.), flights schedules, seats (location, number, etc.), on-site ancillaries (loyalty programs (frequent flyer), meals, carry-on baggage, stored luggage, pets allowance, seat characteristics (leg room, exit), etc.), off-site ancillaries (such as, but not limited to: hotels, rentals, taxis, etc., provided by or associated with other parties), and the like, or any combinations thereof. At step 420, the inventory list is tagged/ assigned and being indexed to one or more of: index of seat map (SSN), schedule of flights index, on-site ancillary index, off-site ancillaries index, and the like, or any combinations thereof. In step 430, an inventory key is generated. The inventory key is configured to allow direct access to the IIN by a remote entity (such as, a search engine). The inventory key may include any type of software protection key capable of preventing unauthorized access to the IIN database. In step 440, the real-time, live availability of the indexed product units is determined. The determination is based on constant updates of the IIN, based on live transactions/offer generation (STIN production), wherein each action in the system affects the actual live availability of the indexed products (for example, a previously available seat was ordered, a flight schedule is changed due to airport considerations, an aircraft goes to urgent maintenance, a pilot is sick, etc.). It is noted that step 440 may be repeated numerous times, as the IIN is continuously being updated. At step 450, a search engine (or other website) is allowed with direct access to the IIN using the inventory key, to receive and/or input information from the IIN. In some embodiments, method 400 is continuously updating availability and/or prices of product units (for example, in step 440). As detailed herein, the IIN may be cloud based, or may be stored on any remote or local server, capable of being updated in real time. In some embodiments, the generated IIN is configured to push updates to the search engine (or website), when at least the prices and/or availability of products are updated.

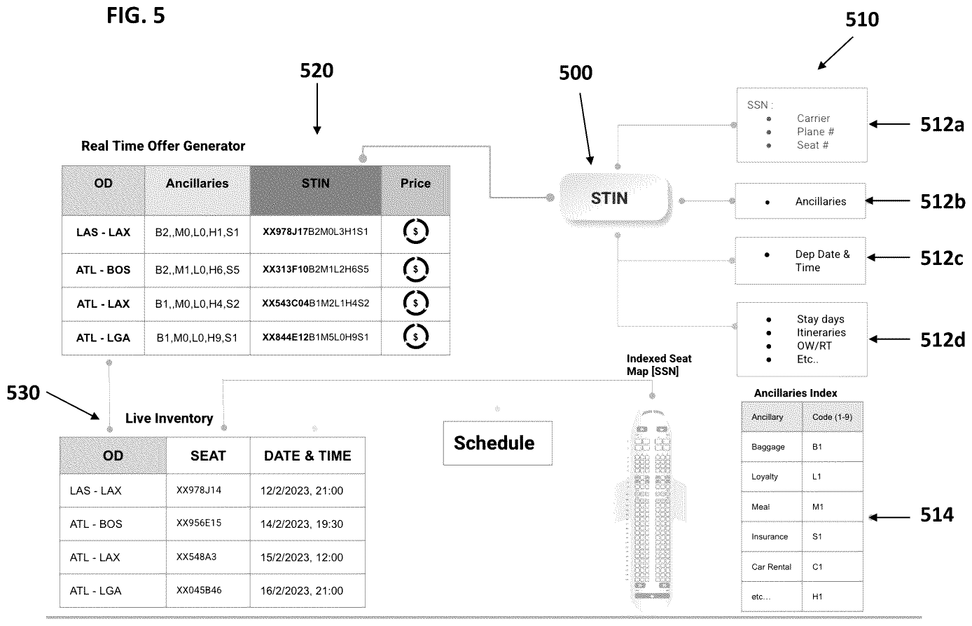

Reference is now made to FIG. 5, schematically showing an outline of exemplary creation, management and traceability of STINs representing travel offers, according to some embodiments. As detailed above, STINs 500 represent a plurality of distinct/one-to one travel offers, each of which includes/represents the various components 510 that are included in a specific offer and allows real-time traceability of each of the components. Such components 510 include, for example, but not limited to: SSN 512a (representing, for example, the airline, plane number, seat number, etc.), various ancillaries 512b (including both on-site and of-site available ancillaries, such as those listed as ancillaries index 514), flight schedule 512c, travel related information 512d, and the like. The generation 520 of STINs (including pricing thereof) is performed in real time by an offer generator (e.g., a regenerative AI matching engine), based at least on a live indexed inventory network (IIN) 530 of the airline, which is continuously being updated in real time, as detailed above and optionally, on one or more additional parameters, such as, for example, user preferences, user characteristics, environmental parameters, and the like. The generation of STIN may be initiated, for example, based on a search prompt from a user (for example, on a search engine or other website), or any other input triggering the generation of an offer (for example, generation of ready-for sale STINs). As shown in FIG. 5, each change in any of the parameters (for example, change in inventory, change in travel preferences, change in ancillaries, generation of STINs, purchase of STINs, etc.), triggers an immediate, real-time change in the IIN, which inn turn affects the generation and/or updating of STINs. Thus, as shown in FIG. 5, each STIN is a dynamic serial number which enables the real-time traceability of the inventory for airlines, and which represents all of the components of a specific offer. Each time the offer is changed/updated, so does the serial number portion signifying which products from the catalog are a part of that offer. As shown in FIG. 5, the STIN is dynamic and can change according to the generation and/or updating thereof, with the price being adjusted accordingly, in real-time, in accordance with the change in other components of the offer. Once a customer checks in to a flight, part of the STIN becomes static and represents the final offer paid for, and the product perishes.

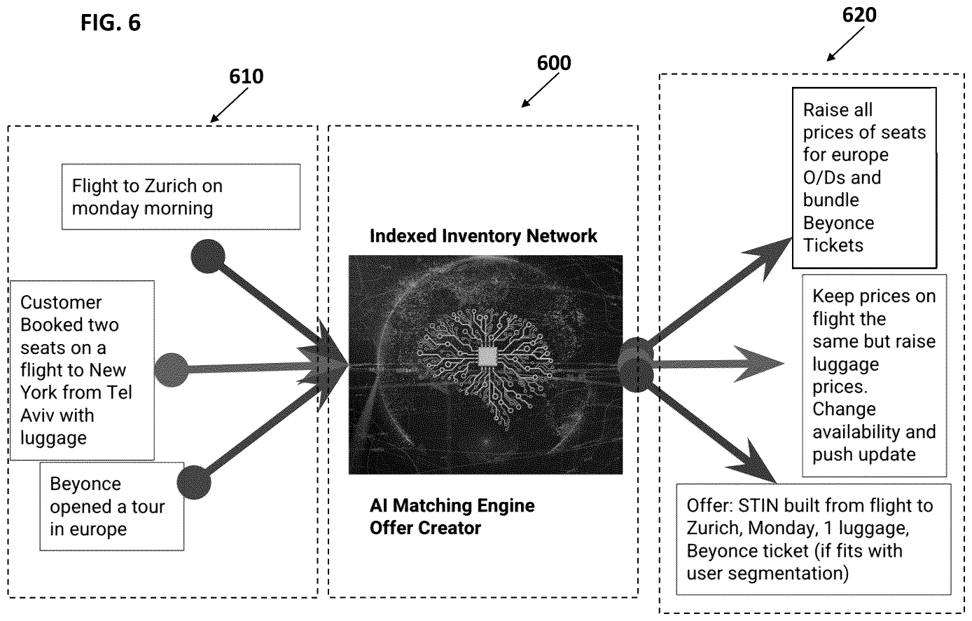

Reference is now made to FIG. 6, which schematically shows an exemplary outline of creation, pricing and publishing of travel offers, using the herein disclosed AI-based platform, according to some embodiments. As shown in FIG. 6, generative AI matching engine offer creator 600, is configured to create and price distinct and unique travel offers in real-time, based on at least on live inventory of airline(s) each represented by its own indexed inventory network and optionally one or more additional parameters/input/sources. To this aim, the AI-platform is configured to receive, collect, monitor or otherwise obtain relevant input 610 from various sources. Such input may include any type of directly or indirectly travel-related input, which are deemed relevant for an offer, by the AI-platform. In some embodiments, the sources are on-line sources. In some embodiments, the input may include input such sources as, but not limited to: search prompts, search preferences, user/costumer-specific related data, user initiated requests, external/environmental data (such as, for example, travel information of other users, general public or other events (such as, concerts, sports games, weather), and the like). Based on the collected input, generative AI matching engine creator can provide output 620, which includes at least one or more travel offers (including pricing thereof, wherein each offer is represented by a unique STIN), as well as optional one or additional outputs, such as outputs for the airline or a supplier, based on a corresponding input. For example, in the example shown in FIG. 6, based on the input, an output of the AI platform may include a specific STIN representing a user-specific (user-customized) offer (signifying all components of the offer, including, flight related information (schedule, destination, seat), on-site ancillaries (such as, luggage, meal), off-site ancillaries such as, concert tickets), price, and the like). Further input for the airline may include, for example, updating prices, in view of changes (and/or expected changes) in availability (for example, increase baggage fees), bundle tickets with concert, and the like. As detailed herein, each change with any of the inputs or outputs is updated in-real time and the update is pushed by the platform to relevant sites.

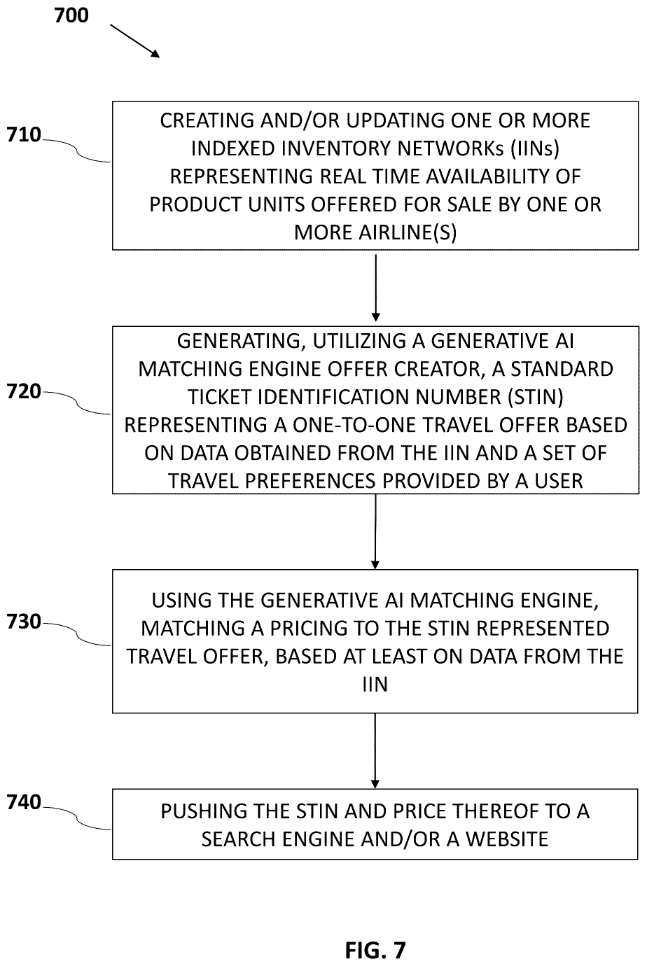

Reference is now made to FIG. 7 showing an illustrative flow chart of a method for creating a traceable dynamic Standard Ticket Identification Number (STIN) representing a travel offer, according to some embodiments. Method 700 includes at step 710 creating and/or updating one or more indexed inventory networks (IINs), each representing real time availability of product units offered for sale by an airline (i.e., each airline has its own IIN). Next, at step 720, a STIN, representing a one to one (distinct/unique) travel offer is generated, utilizing a generative AI matching engine offer creator, based on data obtained from the IIN and one or more or a set of travel preferences provided by a user. Such travel preferences may include a variety of preferences, including origin/destination, schedule of flights, carrier, ancillaries, etc. In some embodiments, the user may be any entity, including, for example, a specific (potential) customer (consumer), a supplier, a service provider, an operator, a travel agent/agency, and the like. At step 730, a price is matched to the STIN represented travel offer, by the generative AI matching engine, based at least on data from the IIN (including, for example, real-time availability), and optionally on one or more directly or indirectly related data (such as, environmental data). At step 740, the STIN including pricing thereof, is pushed to a website (such as an airline web-stie or 3rd party providers), or to a search engine. The push at step 740 may be performed automatically, in real-time, as an STIN is created and/or updated (with respect to its price and any of its components). According to some embodiments, method 700 can allow a user (for example, a supplier or provider) to publish/push up to date offers to various sites, while being able to dynamically and accurately trace the various components included with the offer.

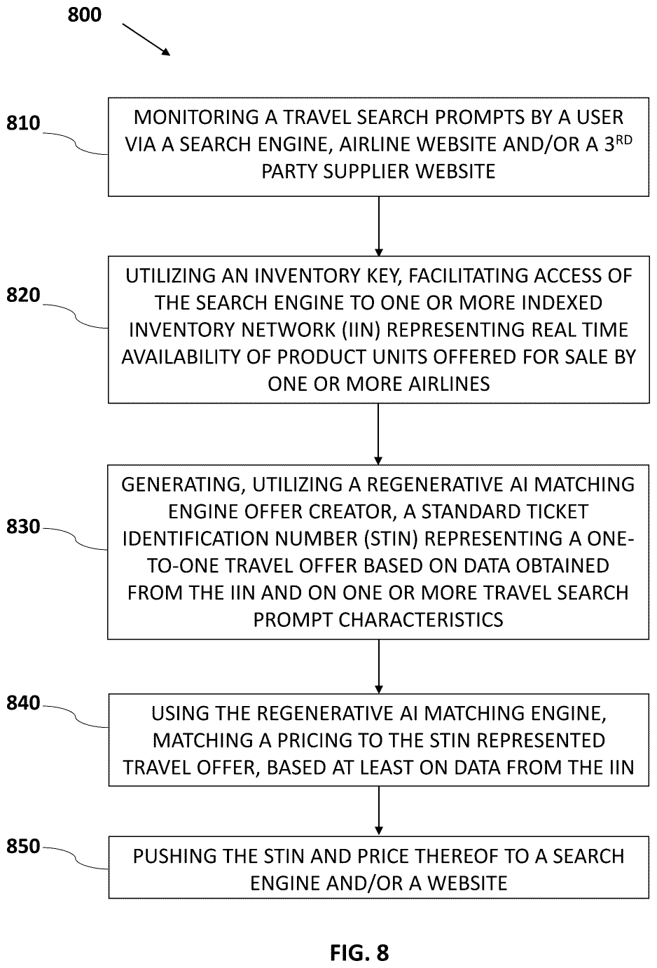

Reference is now made to FIG. 8 showing an illustrative flow chart of a method for creating a traceable dynamic Standard Ticket Identification Number (STIN) representing a travel offer, according to some embodiments. Method 800 includes at step 810 monitoring travel search prompts by a user, via a search engine or other websites (such as, airline website (or API), 3^{rd} party suppliers' websites (or APIs)). The monitoring may be performed continuously or periodically and may be based on key word monitoring, keyword searches, etc. In some embodiments, the monitoring includes actively or passively receiving search prompts from a search engine or other websites. Next, at step 820, access of the search engine or website to one or more indexed inventory networks (IINs) each representing real time availability of product units offer for sale by an airline is facilitated/given/allowed, utilizing a specific inventory key for each of the IINs (or to a plurality of IINs). Next, at step 830, a STIN, representing a one to one (distinct/unique) travel offer is generated, utilizing a generative AI matching engine offer creator, based on data obtained from the IIN and one or more travel search prompts characteristics. Such travel characteristics may include a variety of characteristics, including origin/destination, schedule of flights, carrier, ancillaries, etc. At step 840, a price is matched to the STIN represented travel offer, by the generative AI matching engine, based at least on data from the IIN (including, for example, real-time availability), and optionally on travel characteristics and/or one or more directly or indirectly related data (such as, environmental data). At step 850, the STIN, including pricing thereof, is pushed to a website (such as an airline web-stie or 3^{rd} party providers), or to a search engine. The push at step 740 may be performed automatically, in real-time, as an STIN is created and/or updated (with respect to its price and/or any of its components).

According to some embodiments, generating and utilizing STINs, as disclosed herein, can be utilized in various omnichannel retail setting in various businesses and industries, since all available/offered product units will have a traceable part in the serial number comprising the STIN. Accordingly, for example, airlines using STIN can effectively market flights and bundle offers through all channels, with a direct link to checkout of the exact offer advertised/published, since it is associated with a Dynamic Serial Number that bundles all products of that offer and is updated constantly.

According to some embodiments, STIN-enabled purchasing process by a costumer may include the following steps: i.) the customer searches for a vacation on a search engine; ii.) the search prompt is recognized by the search engine and using the Inventory Key it pushes it into the airlines IIN; iii.) the AI Matching Engine can then create/generate a bespoke STIN with an offer and pushes it with up to date pricing back to the search engine; iv.) the customer will get a link to the airline's site directly to the purchase funnel with the STIN offer; v). The customer can change and add to his order, inducing changes to the STIN and the IIN in the process, (i.e., for every action—a reaction is induced). When the customer purchases the ticket, the STIN may be connected with a PNR (Passenger Name Record), and the offer is saved as purchased. If the customer wants to further change the order after purchase, all changes will also include updated pricing according to the IIN.

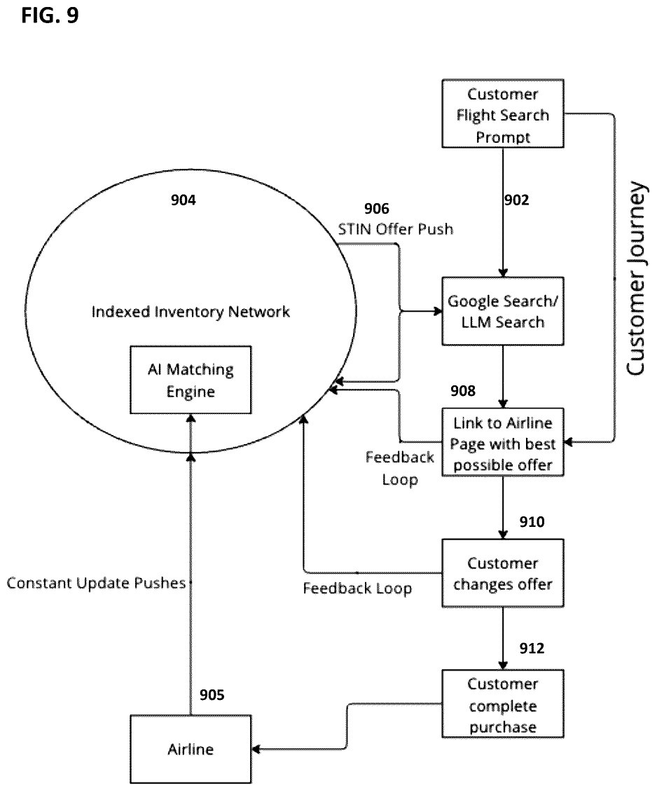

Reference is now made to FIG. 9, which is an illustrative exemplary diagram of an STIN-enabled purchase process of a travel offer by a customer, according to some embodiments. As shown in FIG. 9, the process can start with a flight search prompt 902 provided by a customer (for example, on a search engine (such as, google or Large Language Models (LLM) search) and/or a website. The search engine/website has access (using an inventory key) to one or more indexed inventory networks (IINs) 904 of one or more airlines 905, whereby the AI matching engine as disclosed herein is configured to generate and price specific STINs, based on data from the IIN (i.e., live inventory) and optionally additional relevant data, including, search prompt related data, costumer related data, environmental data, etc. The generated STIN(s) 906 are pushed to the search/engine/website, which in turn can provide a link/access to the customer directing or refereeing the costumer to the airline website page 908 offering the best/optimal/customized offer. At various points along the process, feedback loops between the different components are facilitated, such that changes 910 at different points (induced, for example, because of changes in inventory and/or by the user) are updated and are ultimately reflected in the IIN, and the AI matching engine in real time. Any changes or updates which are induced in the STIN are pushed to the search engine/website, thereby ensuring full traceability of the product units represented by the STIN. The process of updating the STIN may be performed dynamically and continuously. Once the customer has purchased the offer (912), the STIN may be assigned to the specific customer (for example, by assigning a Passenger Name Record (PNR)) to the STIN, while indicating/categorizing the STIN as purchased. Once the costumer travels, the STIN is expired.

According to some embodiments, there is provided a non-transitory memory device, wherein modules of instruction code are stored, and at least one processor associated with the memory device, and configured to execute the modules of instruction code, whereupon execution of said modules of instruction code, the at least one processor is configured to execute one or more of the methods disclosed herein, including, generation/creation of IIN, and generation/creation of STIN.

According to some embodiments, there is provided a system for generating a traceable dynamic Standard Ticket Identification Number (STIN) representing a travel offer, which includes or more processors and, optionally, RAM and/or non-volatile memory components associated with the one or more processors, the processors are configured to execute the method of generating an STIN.

According to some embodiments, there is provided a system for creating an indexed inventory network (IIN), which includes or more processors and, optionally, RAM and/or non-volatile memory components associated with the one or more processors, the processors are configured to execute the method of generating an IIN.

According to an aspect of some embodiments, there is provided a non-transitory computer-readable storage medium. The storage medium stores instructions that cause one or more processors to implement one more of the AI engine specified methods for creation of an STIN.

According to some embodiments, referring to creation and/or updating of STIN also encompass matching (creating) and/or updating pricing thereof.

According to some embodiments, there is provided a computer-readable storage medium having stored therein machine learning software, executable by one or more processors for generating a traceable dynamic Standard Ticket Identification Number (STIN) representing a travel offer.

According to some embodiments, there is provided a computer-readable storage medium having stored therein machine learning software, executable by one or more processors for generating an indexed inventory network.

According to some embodiments, the systems and method disclsoed herein for generation and utilzing STINs are agnositc, and can be used in various settings in different fields and industries and can be implamented with any supplier having a tagged list of all its inventory products.

According to some embodiments, an STIN can be used across industries that make use or offer tickets. In some embodiments, within the travel planning industry, it can be used to bundle various products/experiences.

According to some embodiments, an STIN can be used in logistics industry (such as, for example, air and/or land Freights industry, where creation of IIN is possible, thereby allowing implementation of STIN represented offers.

According to some embodiments, STIN can be used in industries such as, but not limited to financing, banking, Insurance, retail, e-commerce, automotive and manufacturing. Each industry can have its own type of IIN, type of STIN and/or type of generative AI engine.

In the description and claims of the application, the words “include” and “have”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The present invention may be a system, a method, and/or a computer program product. The computer program product may include a computer readable storage medium (or media) having computer readable program instructions thereon for causing a processor to carry out aspects of the present invention.

A computer program (also referred to as a program, software, software application, script or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A computer program can be stored in a portion of a file that holds other programs or data, in a single file dedicated to the program in question, or in multiple coordinated files (for example, files that store one or more modules, sub programs or portions of code). A computer program can be deployed to be executed on one computer or on multiple computers that are located at one site or distributed across multiple sites and interconnected by a communication network.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, for example, JavaScript, Smalltalk, C, C++, TypeScript, Python and R.

The computer readable program instructions may execute entirely on the user's computer, partly on the user's computer, as a stand-alone software package, partly on the user's computer and partly on a remote computer or entirely on the remote computer or server (such as, a cloud based). In the latter scenario, the remote computer (or cloud) may be connected to the user's computer through any type of network, including a local area network (LAN) or a wide area network (WAN), or the connection may be made to an external computer (for example, through the Internet using an Internet Service Provider) including wired or wireless connection (such as, for example, Wi-Fi, BT, mobile, and the like). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Moreover, a computer can be embedded in another device, for example, a mobile phone, a tablet, a personal digital assistant (PDA, or a portable storage device (for example, a USB flash drive). Devices suitable for storing computer program instructions and data include all forms of non-volatile memory, media and memory devices, including semiconductor memory devices, for example, EPROM, EEPROM, random access memories (RAMs), including SRAM, DRAM, embedded DRAM (eDRAM) and Hybrid Memory Cube (HMC), and flash memory devices; magnetic discs, for example, internal hard discs or removable discs; magneto optical discs; read-only memories (ROMs), including CD-ROM and DVD-ROM discs; solid state drives (SSDs); and cloud-based storage. The processor and the memory can be supplemented by, or incorporated in, special purpose logic circuitry.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The processes and logic flows described herein may be performed in whole or in part in a cloud computing environment. For example, some or all of a given disclosed process may be executed by a secure cloud-based system comprised of co-located and/or geographically distributed server systems. The term “cloud computing” is generally used to describe a computing model which enables on-demand access to a shared pool of computing resources, such as computer networks, servers, software applications, and services, and which allows for rapid provisioning and release of resources with minimal management effort or service provider interaction.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While certain embodiments of the invention have been illustrated and described, it will be clear that the invention is not limited to the embodiments described herein. Numerous modifications, changes, variations, substitutions and equivalents will be apparent to those skilled in the art without departing from the spirit and scope of the present invention as described by the claims, which follow.

1.-29. (cancelled)

30. A computer implemented method executable on a processor for creating a traceable dynamic Standard Ticket Identification Number (STIN) representing a travel offer, the computer implemented method comprising:
creating and/or updating one or more Indexed Inventory Networks (IINs) representing real time availability of product units offered for sale by one or more respective airlines, wherein the IIN is continuously updating at least prices and availability of the product units, wherein the IIN is accessible by a search engine utilizing an inventory key;
generating, utilizing a generative AI matching engine, a STIN representing a one-to-one travel offer based on data obtained from the IIN and a set of travel preferences provided by a user, wherein the STIN is dynamically updatable based on relevant changes in the IIN and/or in the travel preferences;
using the generative AI matching engine, matching a pricing to the STIN represented one-to-one travel offer, based at least on data from the IIN; and
pushing the STIN and price thereof to a search engine and/or a website.

31. The method of claim 30, further comprising updating the IIN in real time, upon a generation of the STIN.

32. The method of claim 30, further comprising receiving a travel search prompt via the search engine or website from a customer, wherein the generation or an update of the STIN is further based on one or more travel search prompt characteristics.

33. The method of claim 30, further comprising updating the IIN in real time, upon a purchase of an STIN represented travel offer by a customer.

34. The method of claim 30, further comprising dynamically and traceably updating the STIN based on changes requested by the user and/or a customer or by changes in the IIN.

35. The method of claim 32, further comprising:
inputting to the generative AI matching engine data related to the customer and/or environmental data, thereby generating a personalized STIN; and
updating the matched pricing accordingly.

36. The method of claim 35, wherein data related to the customer comprises prior preferences, prior travel habits, prior travel behavior, financial status, social status, or any combinations thereof; and/or wherein environmental data comprises concerts, sport events, holidays, weather, festivals, or any combinations thereof.

37. The method of claim 30, further comprising updating the matched price.

38. The method of claim 30, wherein the STIN comprises a representation of seat serial number (SSN), departure date and time, on-site ancillaries, off-site ancillaries, length of stay, or any combinations thereof.

39. The method according to claim 38, wherein the on-site ancillaries comprise one of more of: baggage allowance, carry-on baggage allowance, loyalty, frequent flyer, meal(s) type, or any combinations thereof; and/or wherein the off-site ancillaries comprise one of more of: car rentals, excursions, hotels, airport transfers, or any combinations thereof.

40. The method of claim 30, wherein updating the IIN in real time comprises updating data relating to seat map (SSN) and live availability thereof, on-site ancillary index, schedule of flights index, off-site ancillaries index, or any combination thereof.

41. A system for generating a traceable dynamic Standard Ticket Identification Number (STIN) representing a travel offer, the system comprising at least one processor unit configured to execute the method of claim 30.

42. A computer implemented method executable on a processor for creating a traceable dynamic Standard Ticket Identification Number (STIN) representing a travel offer, the computer implemented method comprising:
monitoring travel search prompts by a costumer via a search engine and/or a website;
utilizing an inventory key, facilitating access of the search engine to an Indexed Inventory Networks (IIN) representing real time availability of product units offered for sale by one or more airlines,
generating, utilizing a generative AI matching engine, a STIN representing a one-to-one travel offer based on data obtained from the IIN and on one or more travel search prompt characteristics;
using the generative AI matching engine, matching a pricing to the STIN represented one-to-one travel offer, based at least on data from the IIN; and
pushing the STIN and price thereof to the search engine.

43. The method of claim 42, further comprising providing to the customer a direct link to an airline website or 3^{rd} party supplier for purchasing the travel offer.

44. The method of claim 42, further comprising updating the IIN in real time, upon a purchase of an STIN represented travel offer by the customer and/or further comprising dynamically and traceably updating the STIN based on changes requested by the customer or by changes in the IIN.

45. The method of claim 42, further comprising updating the matched price.

46. A computer-implemented method for creating an Indexed Inventory Network (IIN), the method comprising:
obtaining an inventory list of an airline product units;
indexing the product units by assigning or tagging one or more of the indexes selected from: index of seat map (SSN), on-site ancillary index, schedule of flights index or off-site ancillary index;
generating an inventory key;
determining live availability of indexed product units; and
allowing a search engine access to the IIN, utilizing the inventory key.

47. The method of claim 46, further comprising continuously updating at least prices and availability of the product units in the IIN.

48. The method of claim 46, wherein the IIN is cloud based.

49. The method of claim 46, wherein the IIN is configured to push updates to the search engine, when at least the prices and/or availability of products are updated.
